(19) United States
(12) Patent Application Publication
(10) Pub. No.: US 2025/0233281 A1
(43) Pub. Date: Jul. 17, 2025

(54) CONDUCTIVE MODULE

(71) Applicant: YAZAKI CORPORATION, Tokyo (JP)

(72) Inventors: Katsunori Sato, Makinohara-shi (JP); Tatsuya Oga, Makinohara-shi (JP); Mariko Nakagawa, Makinohara-shi (JP); Masato Tanaka, Makinohara-shi (JP); Daiki Tanaka, Fujieda-shi (JP)

(21) Appl. No.: 19/004,148

(22) Filed: Dec. 27, 2024

(30) Foreign Application Priority Data
Jan. 16, 2024 (JP) 2024-004801

(51) Int. Cl. H01M 50/519; H01M 50/507; H01M 50/569

(52) U.S. Cl. CPC H01M 50/519; H01M 50/507; H01M 50/569

(57) ABSTRACT

A conductive module includes: a bus bar that is physically and electrically connected to electrode terminals of a pair of battery cells in a battery module in which a plurality of battery cells are arranged; a circuit conductor component that includes a circuit conductor for each bus bar and is formed flat, the circuit conductor electrically connecting the bus bar to a battery monitoring unit; a bus bar holding member that holds a plurality of bus bars; and a circuit holding member that holds the circuit conductor component and is capable of being assembled to the bus bar holding member in a state of covering the bus bar at a connection completion position physically and electrically connected to the electrode terminal.

### CROSS-REFERENCE TO RELATED APPLICATION(S)

The present application claims priority to and incorporates by reference the entire contents of Japanese Patent Application No. 2024-004801 filed in Japan on Jan. 16, 2024.

### BACKGROUND OF THE INVENTION

### 1. Field of the Invention

The present invention relates to a conductive module.

### 2. Description of the Related Art

A conductive module is a wiring module that electrically connects a battery module in which a plurality of battery cells are arranged and a battery monitoring unit that monitors battery states of the battery cells. The conductive module includes a bus bar that is physically and electrically connected to electrode terminals of one or a pair of battery cells of the battery module, and an electric wire for each bus bar, the electric wire electrically connects the bus bar to the battery monitoring unit. Further, the conductive module includes a bus bar holding member that holds each bus bar and an electric wire holding member that holds each electric wire. The conductive module is assembled to the battery module to constitute a battery pack together with the battery module. This type of conductive module is disclosed in, for example, Japanese Patent Application Laid-open No. 2018-200753.

Incidentally, in the conventional conductive module, the bus bar held by the bus bar holding member is disposed on the electrode terminal, and the bus bar is physically and electrically connected to the electrode terminal from above the bus bar. Therefore, in the conductive module, the electric wire holding member is disposed adjacent to the bus bar holding member, leaving an empty space above the bus bar. However, in the battery module, an exhaust duct or a restraint member may be disposed in the vicinity of a place where the electric wire holding member is disposed, and in order to reduce the height of the battery module, measures may be taken such as enlarging the exhaust duct or the restraint member toward the electrode terminal to make the exhaust duct or the restraint member thin. In this case, in the battery module, since a region where the electric wire holding member can be arranged becomes narrower, how to secure the arrangement place of the electric wire holding member is a problem. The exhaust duct is a member that communicates with an exhaust valve of each battery cell to release gas inside the battery cell discharged from the exhaust valve to the atmosphere. The restraint member is a member for restraining the respective battery cells in the arrangement state.

### SUMMARY OF THE INVENTION

Therefore, an object of the present invention is to provide a conductive module that can satisfy mounting requirements on a battery module while reducing a height of a battery pack.

A conductive module according to one aspect of the invention includes a bus bar that is physically and electrically connected to electrode terminals of a pair of battery cells in a battery module in which a plurality of battery cells are arranged; a circuit conductor component that includes a circuit conductor for each bus bar and is formed flat, the circuit conductor electrically connecting the bus bar to a battery monitoring unit; a bus bar holding member that holds a plurality of the bus bars; and a circuit holding member that holds the circuit conductor component and is capable of being assembled to the bus bar holding member in a state of covering the bus bar at a connection completion position physically and electrically connected to the electrode terminal.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a conductive module according to an embodiment;

FIG. 2 is an explanatory view for explaining a process of assembling the conductive module according to the embodiment;

FIG. 3 is an explanatory view for explaining the conductive module according to the embodiment, and illustrates a top surface installation form of a circuit conductor component and a circuit holding member;

FIG. 4 is an explanatory view for explaining the conductive module according to the embodiment, and illustrates a side surface installation form of the circuit conductor component and the circuit holding member;

FIG. 5 is a perspective view illustrating a battery module;

FIG. 6 is a perspective view illustrating a conductive module according to a modification;

FIG. 7 is an explanatory view for explaining a process of assembling the conductive module according to the modification;

FIG. 8 is an explanatory view for explaining the conductive module according to the modification, and illustrates a top surface installation form of a circuit conductor component and a circuit holding member; and

FIG. 9 is an explanatory view for explaining the conductive module according to the modification, and illustrates a side surface installation form of the circuit conductor component and the circuit holding member.

### DETAILED DESCRIPTION OF THE PREFERRED EMBODIMENTS

Hereinafter, embodiments of a conductive module according to the present invention will be described in detail with reference to the drawings. Note that the present invention is not limited by these embodiments.

### Embodiment

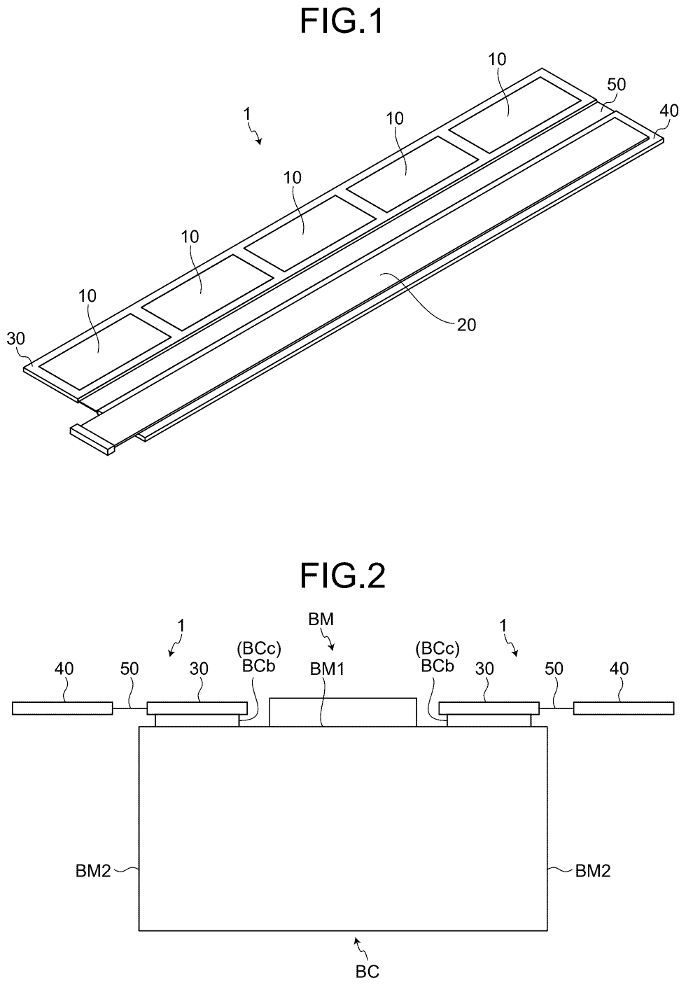

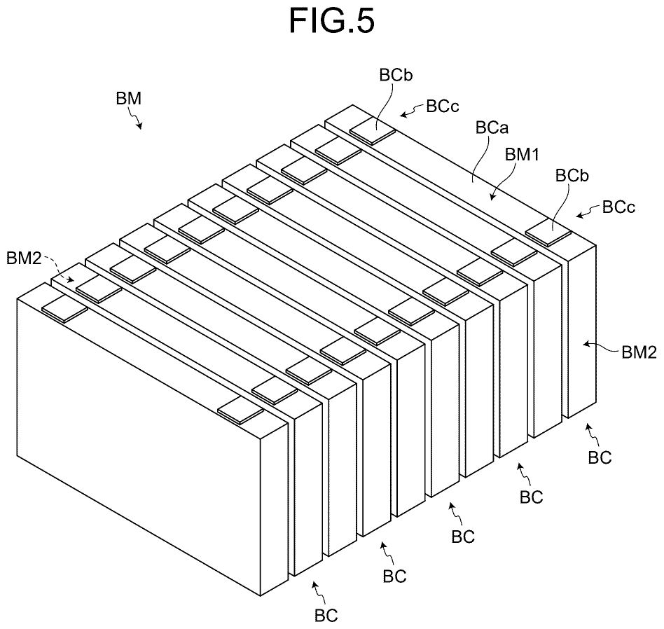

One of embodiments of a conductive module according to the present invention will be described with reference to FIGS. 1 to 5.

Reference numeral 1 in FIGS. 1 to 4 denotes a conductive module according to the present embodiment. A conductive module 1 is assembled to a battery module BM (FIGS. 2 to 5) in which a plurality of battery cells BC are arranged (e.g., arranged in a single row), and the battery module BM is electrically connected to a battery monitoring unit (not illustrated), so that the battery monitoring unit monitors a battery state of the battery cell BC. The conductive module 1 constitutes a battery pack together with the battery module BM. The battery pack is mounted on, for example, a vehicle (BEV: Battery Electric Vehicle, HEV: Hybrid Electric Vehicle, etc.) including a rotary machine as a drive source, and is used for power supply to the rotary machine.

The battery cell BC includes a cell body BCa and positive and negative electrode terminals BCb (FIGS. 2 to 5). In the battery cell BC illustrated here, the cell body BCa is formed in a rectangular parallelepiped shape having six outer wall surfaces. In the plurality of battery cells BC constituting the battery module BM, the cell bodies BCa adjacent to each other in the arrangement direction are arranged with one outer wall surface facing each other. The battery module BM includes one electrode terminal group BCc in which one electrode terminal BCb of each battery cell BC is arranged along the arrangement direction, and the other electrode terminal group BCc in which the other electrode terminal BCb of each battery cell BC is arranged along the arrangement direction (FIGS. 2 to 5).

In this example, each battery cell BC includes positive and negative electrode terminals BCb on one of the six outer wall surfaces of the cell body BCa (FIGS. 2 to 5). Therefore, in the battery module BM, two electrode terminal groups BCc are provided on one plane (hereinafter, referred to as an “electrode installation surface”) BM1 (FIGS. 2 to 5).

The electrode terminal BCb illustrated here is formed in a flat plate shape, and physically and electrically connects a bus bar 10 described later by welding or the like. However, the electrode terminal BCb may be formed in a pole shape having a male screw portion. In this case, the bus bar 10 is screwed and fixed to the electrode terminal BCb by screwing a female screw member to the male screw portion of the electrode terminal BCb.

As the battery cell BC, a pouch type battery cell or a cylindrical battery cell may be used instead of the box type battery cell.

The conductive module 1 includes a bus bar 10 that is physically and electrically connected to the electrode terminals BCb of a pair of battery cells BC in the battery module BM (FIG. 1).

The bus bar 10 is a plate-like conductive component made of a metal, and is press-molded using, for example, a metal plate as a base material. The bus bar 10 illustrated here is formed in a rectangular flat plate shape.

Further, the conductive module 1 includes a circuit conductor component 20 that includes a circuit conductor that electrically connects the bus bar 10 to the battery monitoring unit, and the circuit conductor component 20 is formed flat (FIG. 1). Further, the conductive module 1 includes an electrical connection component (not illustrated, for example, a conductive component such as a terminal fitting or an electric wire) for each bus bar 10 that is physically and electrically connected to the bus bar 10 and the circuit conductor forming a pair and electrically connects the bus bar 10 and the circuit conductor.

As the circuit conductor component 20, for example, a flexible printed circuit board (FPC) on which a conductor pattern as a circuit conductor is formed for each bus bar 10, a printed circuit board (PCB) on which a conductor pattern as a circuit conductor is formed for each bus bar 10, or the like is used. A circuit {for example, a circuit that converts a voltage of a satellite battery module (SBM) connected to each battery cell BC into signal information} having a voltage processing function may be mounted on the printed circuit board. Here, a flexible printed circuit board is used as the circuit conductor component 20.

The conductive module 1 includes a bus bar holding member 30 that holds a plurality of bus bars 10 (FIGS. 1 to 4). The bus bar holding member 30 is formed of an insulating material such as a synthetic resin.

The bus bar holding member 30 is formed flat in a form in which a welding portion with the electrode terminal BCb on one plane of the bus bar 10 and a laser irradiation portion at the time of performing a welding operation with respect to the electrode terminal BCb on the other plane of the bus bar 10 are exposed. The bus bar holding member 30 illustrated here is, for example, insert-molded by pouring a liquid synthetic resin material into a mold in which the bus bars 10 are arranged.

The conductive module 1 includes a circuit holding member 40 that holds the circuit conductor component 20 and can be assembled to the bus bar holding member 30 in a state of covering the bus bar 10 at the connection completion position physically and electrically connected to the electrode terminal BCb (FIGS. 1 to 4). The circuit holding member 40 is formed of an insulating material such as a synthetic resin.

In the conductive module 1 of the present embodiment, a hinge portion 50 that connects the bus bar holding member 30 and the circuit holding member 40 to each other and has a rotation axis along the arrangement direction of the plurality of battery cells BC is provided between the bus bar holding member 30 and the circuit holding member 40 (FIGS. 1 to 4). Here, the bus bar holding member 30 and the circuit holding member 40 are molded as one case component via a living hinge as the hinge portion 50.

In a state where the bus bar 10 held by the bus bar holding member 30 is physically and electrically connected to the electrode terminal BCb, the hinge portion 50 is disposed at a boundary portion between the electrode installation surface BM1 in the battery module BM and an intersecting wall surface BM2 which intersects and is continuous with the electrode installation surface BM1 (FIGS. 2 to 4). In the battery module BM, the electrode installation surface BM1 serves as an upper wall surface and the intersecting wall surface BM2 serves as a side wall surface when the battery module BM is mounted on a vehicle.

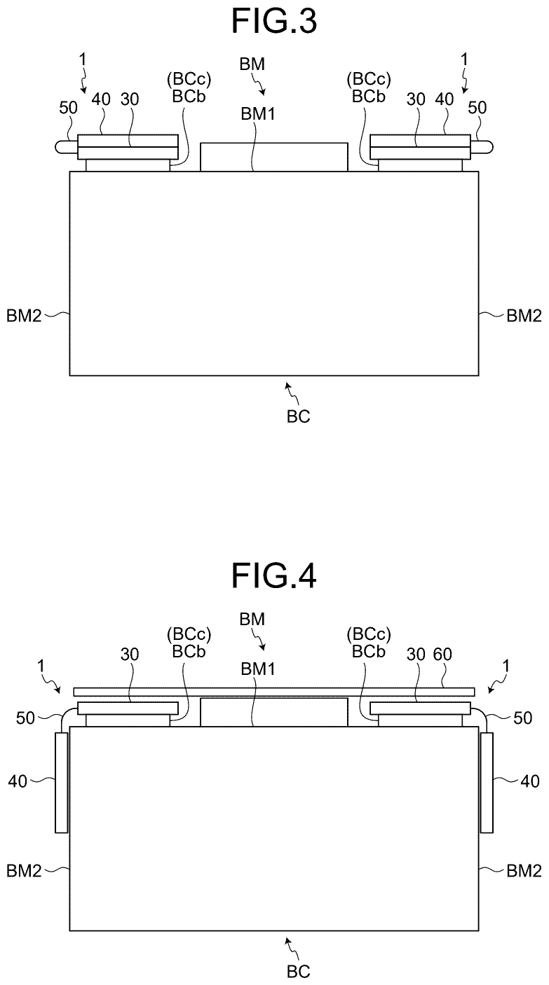

In the conductive module 1, the circuit holding member 40 can be disposed at a first installation position (FIG. 3) where the circuit holding member 40 is rotated around the rotation axis of the hinge portion 50 with respect to the bus bar holding member 30 and assembled to the bus bar holding member 30 in a state of covering the bus bar 10 at the connection completion position, or a second installation position (FIG. 4) where the circuit holding member 40 is rotated around the rotation axis of the hinge portion 50 with respect to the bus bar holding member 30 and disposed to face the intersecting wall surface BM2. In the conductive module 1, the bus bar 10 and the circuit conductor are electrically connected to each bus bar 10 by the previous electrical connection component.

In the conductive module 1, the bus bar 10 held by the bus bar holding member 30 is placed on the electrode terminal BCb for each bus bar 10, and each bus bar 10 is connected to the electrode terminal BCb by laser welding or the like (FIG. 2).

In the conductive module 1, the circuit holding member 40 holding the circuit conductor component 20 is rotated to the first installation position around the rotation axis of the hinge portion 50, and the circuit holding member 40 is assembled to the bus bar holding member 30 (FIG. 3). For example, in this case component, a lock mechanism (not illustrated) using a claw portion or the like is provided between the bus bar holding member 30 and the circuit holding member 40, and the circuit holding member 40 is held by the bus bar holding member 30 at the first installation position by the lock mechanism.

The circuit holding member 40 at the first installation position also functions as a cover member for insulation protection that covers the bus bar 10 in a space above the bus bar holding member 30. Therefore, in the conductive module 1 in this case, it is not necessary to separately prepare such a cover member, and the number of components can be reduced.

On the other hand, in the conductive module 1, when the space above the bus bar holding member 30 cannot be used for installation of the circuit holding member 40, the circuit holding member 40 holding the circuit conductor component 20 is rotated to the second installation position around the rotation axis of the hinge portion 50, and the circuit holding member 40 is assembled to face the intersecting wall surface BM2 of the battery module BM (FIG. 4). For example, here, a lock mechanism (not illustrated) using a claw portion or the like is provided between the circuit holding member 40 and the intersecting wall surface BM2, and the circuit holding member 40 is held on the intersecting wall surface BM2 at the second installation position by the lock mechanism.

In this case, a cover member 60 for insulation protection that covers the bus bar 10 in a space above the bus bar holding member 30 is separately prepared, and the cover member 60 is assembled to the bus bar holding member 30 (FIG. 4).

As described above, when the circuit holding member 40 cannot be installed adjacent to the bus bar holding member 30 on the electrode installation surface BM1 due to the height reduction requirements of the battery pack, the conductive module 1 of the present embodiment can satisfy the mounting requirements on the battery module BM while reducing the height of the battery pack by stacking the circuit holding member 40 at the first installation position on the bus bar holding member 30. As described above, in the conductive module 1, since the circuit holding member 40 can be used as a cover member for insulation protection that covers the bus bar 10 in the space above the bus bar holding member 30, the number of components can be reduced.

In addition, even when the space above the bus bar holding member 30 cannot be used for installation of the circuit holding member 40, the conductive module 1 of the present embodiment can be installed on the side wall surface (intersecting wall surface BM2) of the battery module BM only by rotating the circuit holding member 40 to the second installation position around the rotation axis of the hinge portion 50.

### Modification

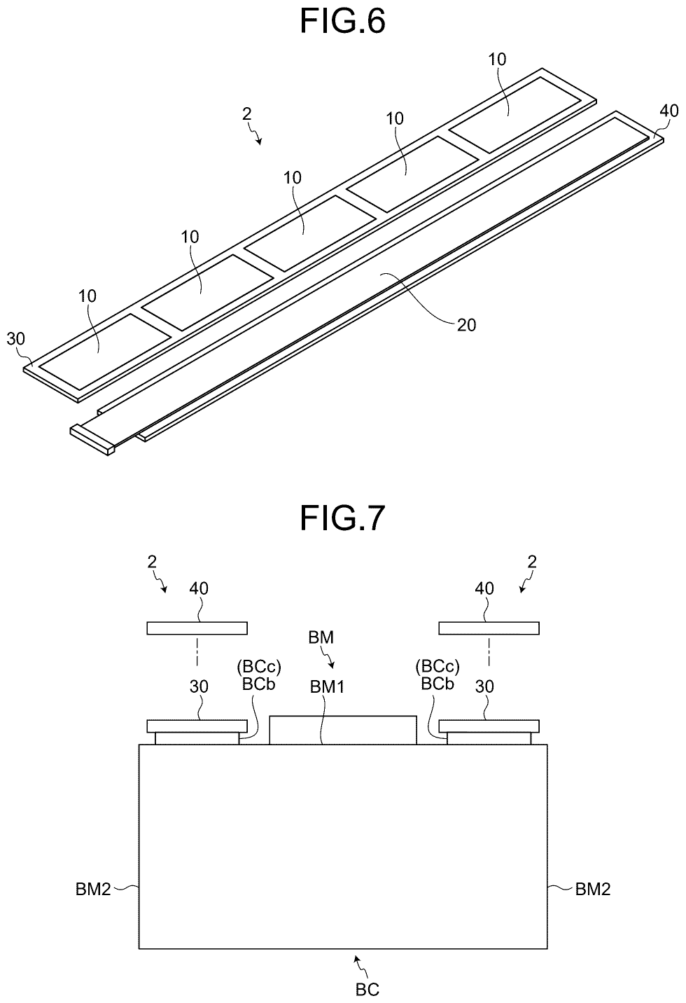

In a conductive module 2 of the present modification, the bus bar holding member 30 and the circuit holding member 40 are prepared as individual components without providing the hinge portion 50 in the conductive module 1 of the above-described embodiment (FIGS. 6 to 9). Therefore, in the conductive module 2 of the present modification, portions and the like similar to those of the conductive module 1 of the embodiment are denoted by the same reference numerals as those of the embodiment, and the description thereof will be omitted.

The bus bar holding member 30 of the present modification includes a first engagement portion (not illustrated). The battery module BM of the present modification includes a first engagement portion (not illustrated) having the same shape as the first engagement portion of the bus bar holding member 30 on the intersecting wall surface BM2.

The circuit holding member 40 of the present modification example includes a second engagement portion (not illustrated) which is capable of maintaining an assembly completion state with the bus bar holding member 30 by being engaged with the first engagement portion of the bus bar holding member 30 when the circuit holding member 40 is assembled to the bus bar holding member 30 in a state of covering the bus bar 10 at the connection completion position, and capable of maintaining an assembly completion state with the battery module BM by being engaged with the first engagement portion of the intersecting wall surface BM2 when the circuit holding member 40 is assembled to the battery module BM in a state of facing the intersecting wall surface BM2. The first engagement portion and the second engagement portion are, for example, a lock mechanism in which one of the first engagement portion and the second engagement portion has a claw portion, and the claw portion is hooked on the other of the first engagement portion and the second engagement portion to engage the first engagement portion and the second engagement portion with each other.

In the conductive module 2 of the present modification, the bus bar 10 held by the bus bar holding member 30 is placed on the electrode terminal BCb for each bus bar 10, and each bus bar 10 is connected to the electrode terminal BCb by laser welding or the like (FIG. 7).

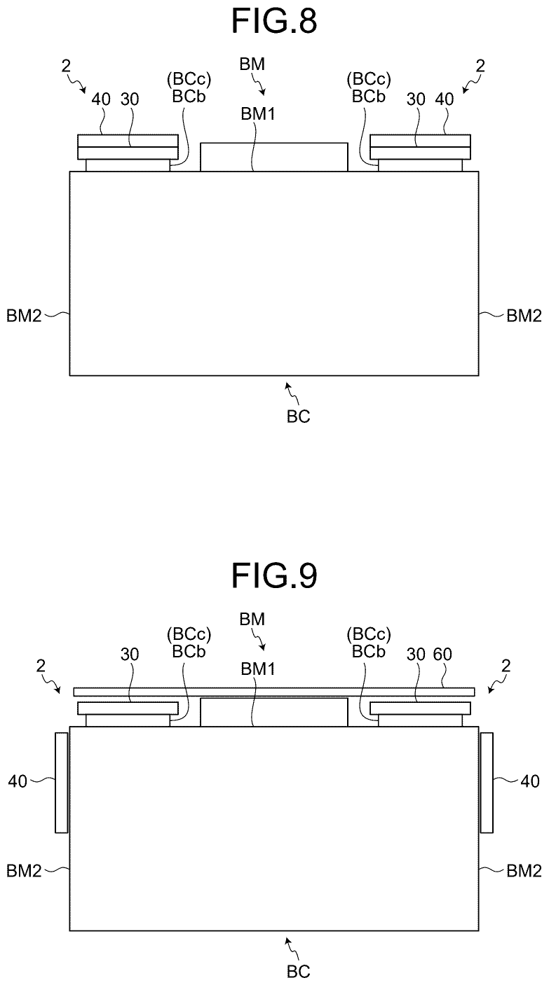

In the conductive module 2, the circuit holding member 40 holding the circuit conductor component 20 is assembled on the bus bar holding member 30, and the assembly completion state is maintained by the previous lock mechanism (the first engagement portion and the second engagement portion) (FIG. 8).

In the conductive module 2, for example, when the electrical connection component (here, a terminal fitting) of the embodiment is used, the bus bar 10 and the circuit conductor are electrically connected by the electrical connection component in a process of assembling the circuit holding member 40 holding the circuit conductor component 20 on the bus bar holding member 30. For example, here, the electrical connection component assembled to the circuit conductor is assembled to the bus bar 10 simultaneously with the assembling of the bus bar holding member 30 and the circuit holding member 40. In this case, the bus bar 10 is provided with a terminal portion that can be fitted and connected to the electrical connection component.

In addition, when such an electrical connection component is not used, the circuit conductor is provided with a conductor connection portion that is disposed to face the bus bar 10 in a state where the bus bar holding member 30 and the circuit holding member 40 are assembled, and physically and electrically connected to the facing bus bar 10 (not illustrated). In this case, for example, the circuit holding member 40 has a shape that exposes both planes of the circuit conductor component 20. In the conductive module 2, the conductor connection portion of the circuit conductor is connected to the bus bar 10 by laser welding or the like.

The circuit holding member 40 also functions as a cover member for insulation protection that covers the bus bar 10 in a space above the bus bar holding member 30. Therefore, in the conductive module 2 in this case, it is not necessary to separately prepare such a cover member, and the number of components can be reduced. However, when the bus bar 10 and the conductor connection portion of the circuit conductor are connected by laser welding or the like, one plane of the circuit conductor component 20 is exposed, so that it is necessary to separately prepare a cover member for insulation protection that covers one plane.

On the other hand, in the conductive module 2, when the space above the bus bar holding member 30 cannot be used for installation of the circuit holding member 40, the circuit holding member 40 holding the circuit conductor component 20 is assembled to face the intersecting wall surface BM2 of the battery module BM, and the assembly completion state is maintained by the previous lock mechanism (the first engagement portion and the second engagement portion) (FIG. 9).

In this case, similarly to the installation form of the circuit holding member 40 in the embodiment, a cover member 60 for insulation protection that covers the bus bar 10 in a space above the bus bar holding member 30 is separately prepared, and the cover member 60 is assembled to the bus bar holding member 30 (FIG. 9).

As described above, when the circuit holding member 40 cannot be installed adjacent to the bus bar holding member 30 on the electrode installation surface BM1 due to the height reduction requirements of the battery pack, the conductive module 2 of the present modification can satisfy the mounting requirements on the battery module BM while reducing the height of the battery pack by stacking the circuit holding member 40 on the bus bar holding member 30. As described above, in the conductive module 2, when the bus bar 10 and the circuit conductor are electrically connected by the electrical connection component, the circuit holding member 40 can be used as a cover member for insulation protection that covers the bus bar 10 in the space above the bus bar holding member 30, so that the number of components can be reduced.

In addition, in the conductive module 2 of the present modification, even when the space above the bus bar holding member 30 cannot be used for installation of the circuit holding member 40, the first engagement portion engageable in pair with the second engagement portion of the circuit holding member 40 is provided on both the bus bar holding member 30 and the side wall surface (intersecting wall surface BM2) of the battery module BM, so that the circuit holding member 40 can be installed on the side wall surface (intersecting wall surface BM2) of the battery module BM without increasing the number of components.

When a circuit holding member cannot be installed adjacent to a bus bar holding member on an electrode installation surface due to height reduction requirements of a battery pack, the conductive module according to the embodiment can satisfy mounting requirements on the battery module while reducing the height of the battery pack by stacking the circuit holding member on the bus bar holding member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
a bus bar that is physically and electrically connected to electrode terminals of a pair of battery cells in a battery module in which a plurality of battery cells are arranged;
a circuit conductor component that includes a circuit conductor for each bus bar and is formed flat, the circuit conductor electrically connecting the bus bar to a battery monitoring unit;
a bus bar holding member that holds a plurality of the bus bars; and
a circuit holding member that holds the circuit conductor component and is capable of being assembled to the bus bar holding member in a state of covering the bus bar at a connection completion position physically and electrically connected to the electrode terminal.

2. The conductive module according to claim 1, wherein
a hinge portion connecting the bus bar holding member and the circuit holding member to each other and having a rotation axis along an arrangement direction of the plurality of battery cells is provided between the bus bar holding member and the circuit holding member,
the hinge portion is disposed at a boundary portion between an electrode installation surface of the battery module on which the electrode terminal is provided and an intersecting wall surface which intersects and is continuous with the electrode installation surface in a state where the bus bar held by the bus bar holding member is physically and electrically connected to the electrode terminal, and
the circuit holding member is disposed at a first installation position where the circuit holding member is rotated around the rotation axis of the hinge portion with respect to the bus bar holding member and assembled to the bus bar holding member in a state of covering the bus bar at the connection completion position, or a second installation position where the circuit holding member is rotated around the rotation axis of the hinge portion with respect to the bus bar holding member and disposed to face the intersecting wall surface.

3. The conductive module according to claim 1, wherein
the bus bar holding member includes a first engagement portion,
the battery module includes a first engagement portion having the same shape as the first engagement portion of the bus bar holding member on an intersecting wall surface intersecting and continuous with an electrode installation surface on which the electrode terminal is provided, and
the circuit holding member includes a second engagement portion that is capable of maintaining an assembly completion state with the bus bar holding member by being engaged with the first engagement portion of the bus bar holding member when the circuit holding member is assembled to the bus bar holding member in a state of covering the bus bar at the connection completion position, and capable of maintaining an assembly completion state with the battery module by being engaged with the first engagement portion of the intersecting wall surface when the circuit holding member is assembled to the battery module in a state of facing the intersecting wall surface.

4. The conductive module according to claim 1, wherein
the circuit conductor is provided with a conductor connection portion that is disposed to face the bus bar in a state where the bus bar holding member and the circuit holding member are assembled, and physically and electrically connected to the facing bus bar.

5. The conductive module according to claim 1, further comprising:
an electrical connection component for each bus bar that is physically and electrically connected to the bus bar and the circuit conductor forming a pair and electrically connects the bus bar and the circuit conductor.

6. The conductive module according to claim 2, further comprising:
an electrical connection component for each bus bar that is physically and electrically connected to the bus bar and the circuit conductor forming a pair and electrically connects the bus bar and the circuit conductor.

7. The conductive module according to claim 3, further comprising:
an electrical connection component for each bus bar that is physically and electrically connected to the bus bar and the circuit conductor forming a pair and electrically connects the bus bar and the circuit conductor.
